(19) United States
(12) Patent Application Publication
(10) Pub. No.: US 2024/0154358 A1
(43) Pub. Date: May 9, 2024

(54) HYBRID CONNECTOR SYSTEM

(71) Applicant: Winchester Interconnect Corporation, Norwalk, CT (US)

(72) Inventor: John E. Benham, Torrington, CT (US)

(73) Assignee: Winchester Interconnect Corporation, Norwalk, CT (US)

(21) Appl. No.: 18/386,665

(22) Filed: Nov. 3, 2023

Related U.S. Application Data
(60) Provisional application No. 63/423,159, filed on Nov. 7, 2022.

(51) Int. Cl. H01R 13/627; H01R 13/514

(52) U.S. Cl. CPC H01R 13/6272; H01R 13/514

(57) ABSTRACT

A hybrid plug. The hybrid plug includes a metallic plug body and a latching shroud connected to the plug body. The latching shroud is configured for engaging with a corresponding hybrid socket. The plug body has a first cavity for receiving a power cable for delivering power, and further has a second cavity for receiving a signal cable for carrying a data signal.

### CROSS-REFERENCE TO RELATED APPLICATION(S)

This application claims the benefit of U.S. Provisional Patent Application No. 63/423,159, filed on 2022 Nov. 7, which is incorporated by this reference.

### TECHNICAL FIELD

Disclosed are embodiments related to a hybrid connector system.

### BACKGROUND

Road safety has vastly increased due to developments known as “Advanced Driver Assistance Systems (ADAS).” Some ADAS technologies take effect autonomously (e.g., operating a vehicle with complete control).

In ADAS applications involving cameras, a critical design challenge is to transfer as quickly and efficiently as possible image data from a camera to a processing unit and from the processing unit to a display. Some of the key tradeoffs in designing ADAS camera systems are image quality, bandwidth, latency, reliability, cost, and power consumption.

### SUMMARY

Certain challenges presently exist. For instance, autonomous system (e.g., robots, and driverless vehicles, etc.) rely on sensors (e.g., high-resolution light detection and ranging (LiDAR) sensors, cameras, etc.) that produce a huge amount data, and this data needs to be provided to a processing unit for analysis; hence, in many uses cases, autonomous system require a data transfer link with high capacity and low latency (e.g., a gigabit multimedia serial link (GMSL) with very low latency). At a speed of 100 kilometers/hour, a vehicle travels 91.13 ft (27.8 m) every second; accordingly, for passenger and traffic safety, every second counts.

Industry standard connectors, such a Fachkreis Automobil (FAKR) connectors, are well established and use a SubMinature version B (SMB) connector in keyed and color code plastic housings. These connectors often use power over coax to support low power requirements and cannot support the power voltage and amperage required by some sensors.

To overcome these issues, this disclosure provides a hybrid connector with both signal (e.g. radio frequency (RF)) connectors (e.g., SMB connector which operates 0-4 GHz and can support interfaces up to 40 GHz) and power connectors housed in a metal housing.

Accordingly, in one aspect, there is provided a hybrid plug. The hybrid plug includes a metallic plug body and a latching shroud connected to the plug body. The latching shroud is configured for engaging with a corresponding hybrid socket. The plug body has a first cavity for receiving a power cable for delivering power, and further has a second cavity for receiving a signal cable for carrying a data signal.

In another aspect, there is provided a hybrid socket. The hybrid socket includes a metallic socket body; a first power pin for matting with a corresponding power socket of a power cable; and a signal connector for mating with a corresponding signal cable. Both the power pin and the signal connector are housed within the metallic socket body.

An advantage of the embodiments disclosed herein is that they provide electromagnetic interference (EMI) and RF isolation and the power connector included in the connector assembly supports power requirements.

### BRIEF DESCRIPTION OF THE DRAWINGS

The accompanying drawings, which are incorporated herein and form part of the specification, illustrate various embodiments.

FIG. 1 illustrates a hybrid connector system according to some embodiments.

FIG. 2 is a view of the front of the hybrid plug according to some embodiments.

FIG. 3 further illustrates the hybrid plug according to some embodiments.

FIG. 4 is a view of the rear of the hybrid plug according to some embodiments.

FIG. 5 is a perspective view of the hybrid plug according to some embodiments.

FIG. 6 illustrates the function of the locking pin according to some embodiments.

FIG. 7 illustrates a latching shroud according to some embodiments.

FIG. 8 illustrates the hybrid socket according to some embodiments.

FIG. 9 is a view of the rear of the hybrid socket according to some embodiments.

FIG. 10 is a cross-sectional view of a socket according to some embodiments.

FIG. 11 shows that in some embodiments the power cable and signal cable are independently environmentally sealed.

FIG. 12 illustrates a plug body according to some embodiments.

FIG. 13 is a cross-sectional view of a plug body and RF contact according to some embodiments.

FIG. 14 is a cross-sectional view of a socket according to some embodiments.

FIG. 15 illustrates the protective cover according to some embodiments.

### DETAILED DESCRIPTION

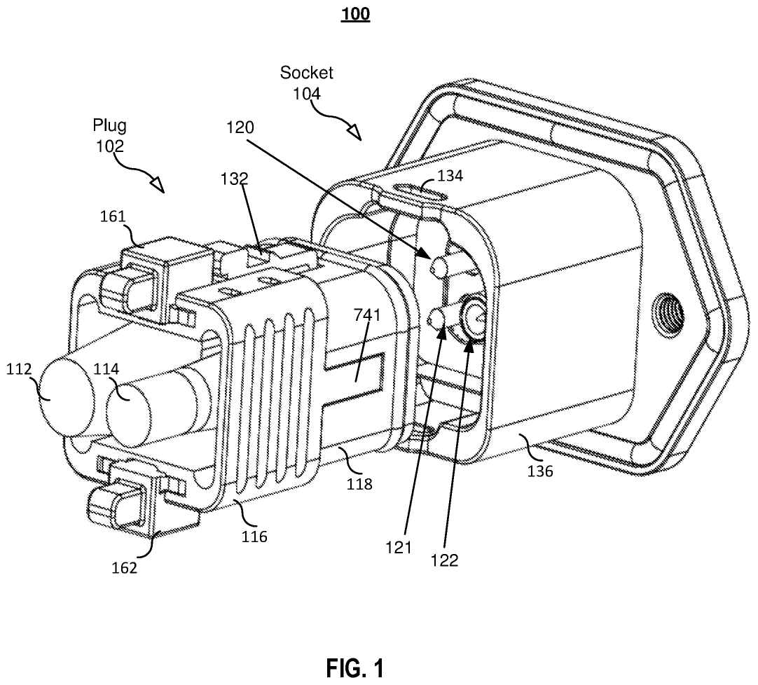

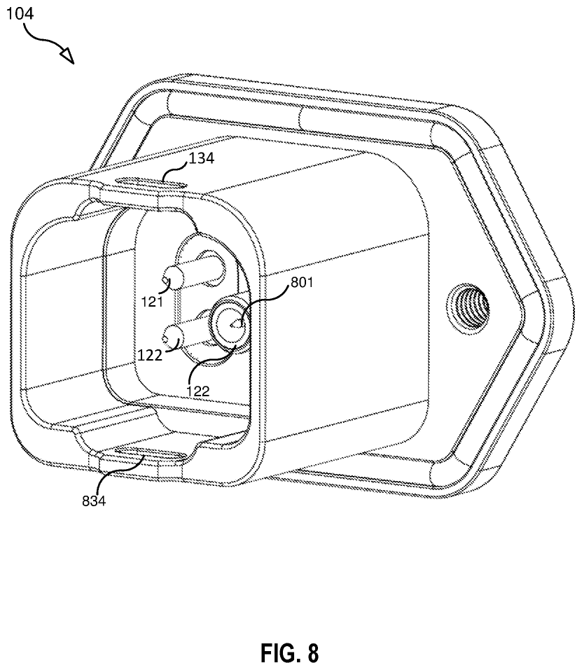

FIG. 1 illustrates a hybrid connector system 100 according to an embodiment. Hybrid connector system (HCS) 100 includes a hybrid plug 102 configured to mate with a corresponding hybrid socket 104 (see also FIG. 8), which is configured to be mounted to a panel or circuit board or other surface. As illustrated in FIG. 1, plug 102 is configured to house both a power cable assembly 112 for delivering power and a data signal cable assembly 114 (e.g., a cable assembly comprising an SMB type coaxial contact) for carrying high-frequency data signals, and socket 104 includes a set of one or more power pins for mating with receptacles at the end of power cable assembly 112 and a data signal connector 122 (e.g., coaxial connector) for mating with data signal cable assembly 114 (see also FIG. 8).

As further illustrated in FIG. 1, plug 102 includes a metallic plug body 118 and a latching shroud 116 connected to plug body 118. The latching shroud 116 is configured with at least one snap-lock hook 132 for engaging with a corresponding undercut 134 (which in this case is a hole) (see also FIG. 8) formed at a distal end of the metallic body 136 of socket 104. In one embodiment, metallic body 136 is made from keyed metal.

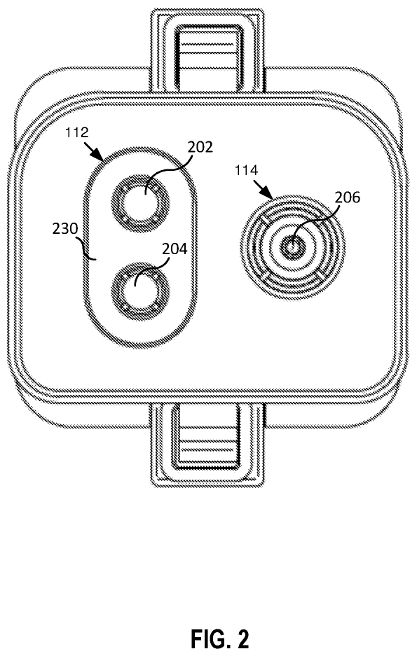

FIG. 2 is a front view of plug 102, according to one embodiment, which shows the end portion of power cable assembly 112 and the end portion of signal cable assembly 114. As shown in FIG. 2, end portion of power cable assembly 112 includes electrically insulative housing 230 housing a first power socket 202 configure to receive a first power pin (e.g., power pin 120 of socket 104) and a second power socket 204 configure to receive a second power pin (e.g., power pin 121 of socket 104); end portion of signal cable assembly 114 in this embodiment includes a female signal contact 206 for mating with a corresponding male signal contact of connector 122 of socket 104.

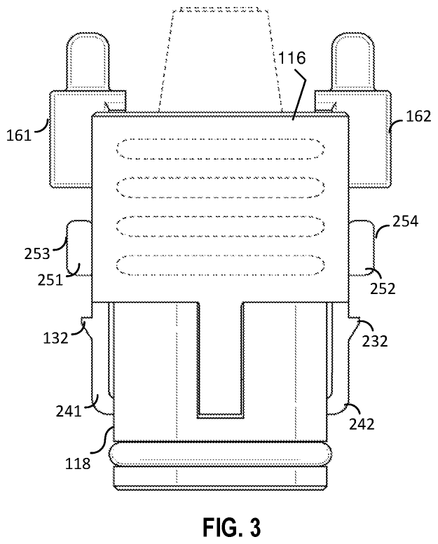

FIG. 3 further illustrates plug 102, and shows that latching shroud 116 includes not only hook 132 for snap-locking plug 102 into socket 104, but also as second hook 232 snap-locking plug 102 into socket 104. Hook 132 is formed on a first u-shaped cantilever arm 241 and hook 232 is formed on a second u-shaped cantilever arm 242. When plug 102 is engaged with socket 104, hooks 132 and 232 are engaged with corresponding undercuts in the body of socket 104. To disengage the hooks 132, 232 from the corresponding undercuts, a user can press inward on the distal end 251 of arm 241 (a.k.a., “connector release latch 251”) and the distal end 252 of arm 242 (a.k.a., “connector release latch 252”), thereby causing the cantilever arms to flex inwardly and thereby disengaging the hooks from the body of socket 104. To facilitate this unlocking, connector release latch 251 has a raised surface 253 and connector release latch 252 has a raised surface 254.

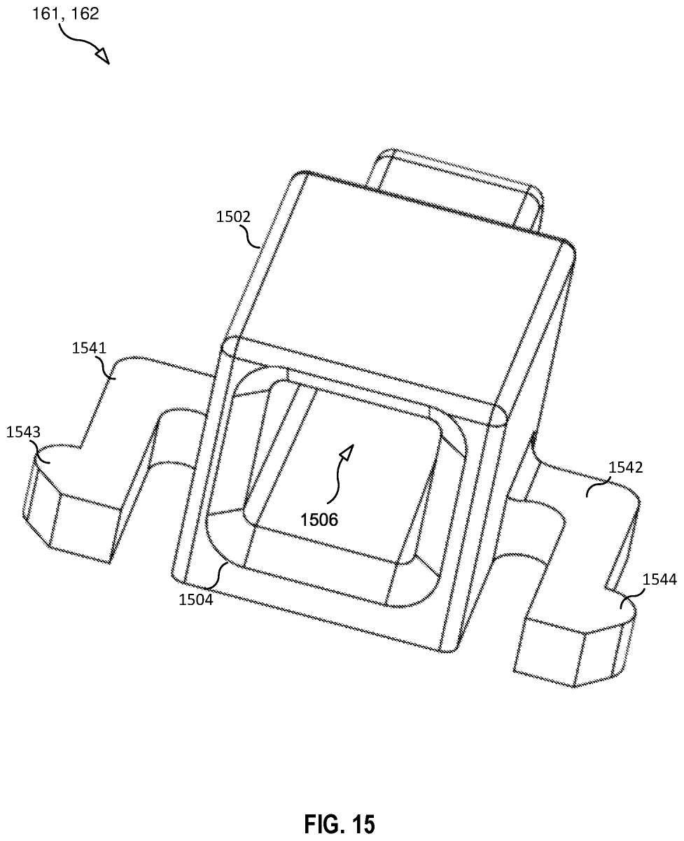

To prevent accidental disengagement, latching shroud 116 includes a first moveable protective cover 161 for covering connector release latch 251 and second moveable protective cover 162 for covering connector release latch 252. Moveable protective cover 161 can slide between a first position (shown in FIG. 3) in which connector release latch 251 is exposed and a second position in which cover 161 covers connector release latch 251 so that it is not exposed. Likewise, protective cover 162 can slide between a first position (shown in FIG. 3) in which connector release latch 252 is exposed and a second position in which cover 162 covers connector release latch 252 so that it is not exposed. The protective cover 161, 162, according to one embodiment, is illustrated in FIG. 15. In this embodiment the protective cover is in the form of a housing 1502 having side surfaces (e.g., five side surfaces in this example) that define an opening 1504 leading to a cavity 1506 within the housing 1502. When the housing 1502 is moved into the second position (i.e., the “blocking” position), the corresponding connector release latch 251, 252 will be disposed in the cavity 1506 of the housing, thereby preventing unintentional disengagement of the plug from the socket. As further illustrated in FIG. 15, a first cantilever arm 1541 is connected to a first side of housing 1502 and a second cantilever arms 1542 is connected to a second side of housing 1502, which is opposite the first side of housing 1502. Arm 1541 has a hook 1543 at its distal end for engaging with a recess in latching shroud 116 when housing 1502 is moved to the blocking position; likewise and arm 1542 has a hook 1544 for engaging with a recess in latching shroud 116 when housing 1502 is moved to the blocking position, thereby snap-locking housing 1502 in the blocking position and preventing an unintentional movement of housing 1502 out of the blocking position.

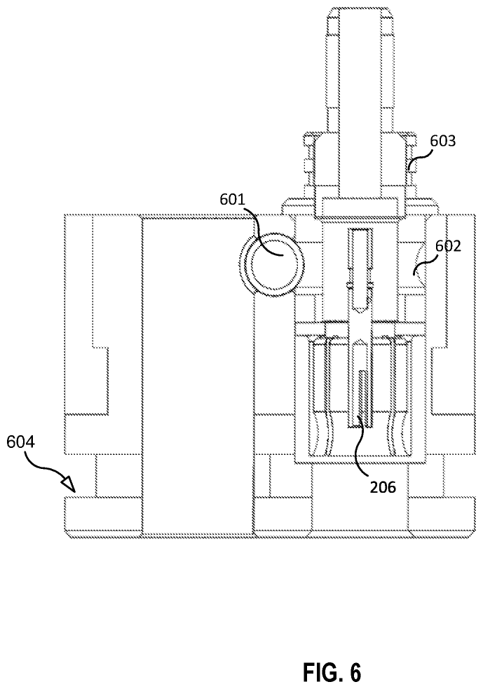

As further shown in FIG. 3, to create an environmental seal, a resilient o-ring sits in a circumferential groove 604 (see FIG. 6) formed in the distal end portion of plug body 118.

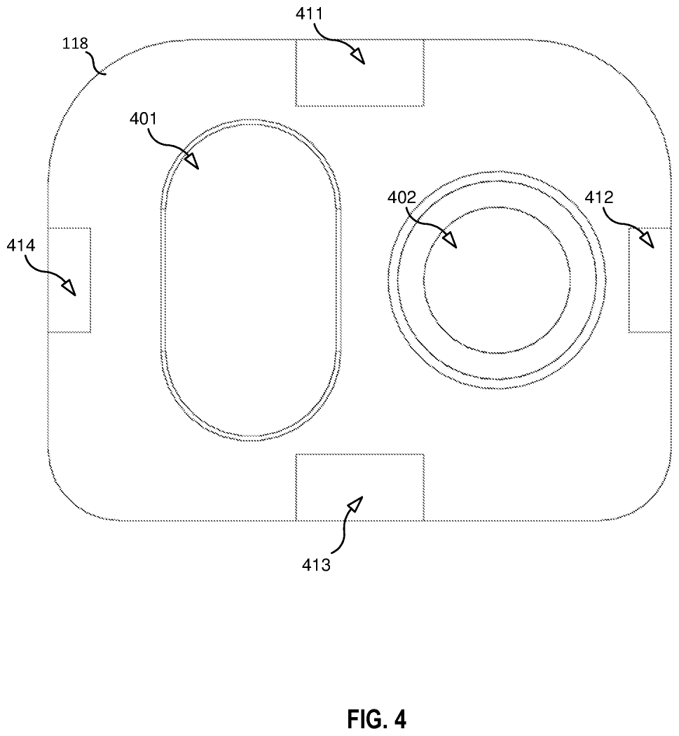

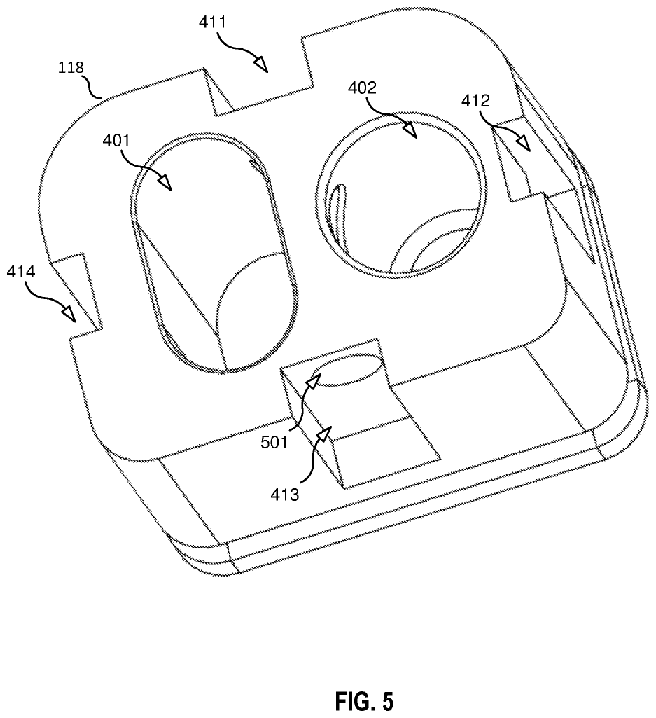

FIG. 4 is view of the rear of plug body 118, and FIG. 5 is a perspective view of body 118. As shown in FIG. 4 and FIG. 5, plug body 118 has a first cavity 401 extending from the rear of the body to the front of the body for receiving the power cable assembly 112 and has a second cavity 402 extending from the rear of the body to the front of the body for receiving the signal cable assembly 114.

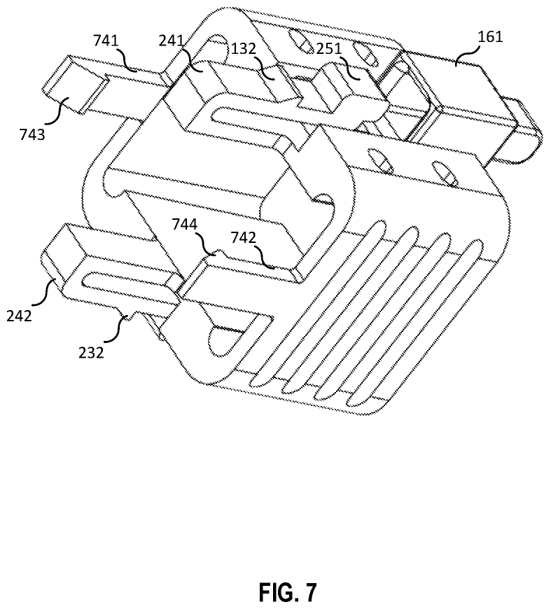

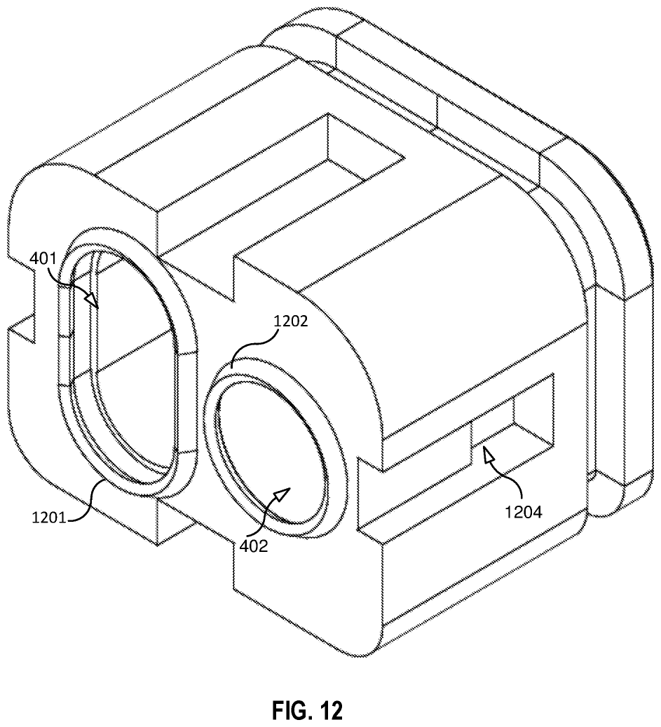

As also shown in FIG. 4 and FIG. 5, body 118 has four sides and a channel is formed in each side. Channels 411 and 413 are configured to receive the u-shaped cantilever arms 241 and 242 of latching shroud 116 (see FIG. 2 and FIG. 7). Channels 412 and 414 are configured to receive cantilever locking arms 741 and 742 of latching shroud 116 (see FIG. 7). As shown in FIG. 7, locking arm 741 has a hook 743 at its distal end for engaging with a recess 1204 (see FIG. 12) in channel 412 and locking arm 742 has a hook 744 for engaging with a recess in channel 413, thereby snap-locking latching shroud 116 to plug body 118.

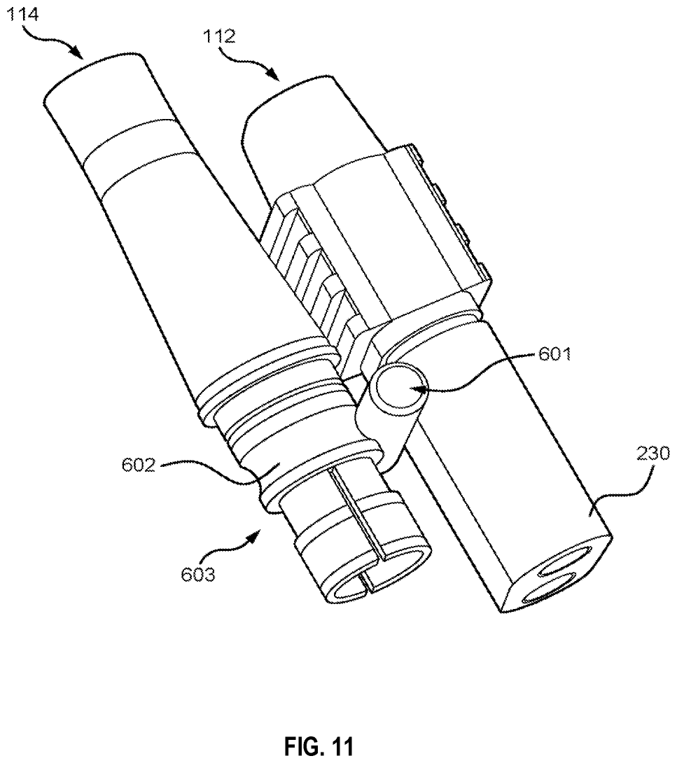

Referring to FIG. 5, FIG. 5 shows that plug body 118 has a transverse cavity 501 that extends from the bottom wall of channel 413 inwardly into body 118. Cavity 501 is configured to receive a lock pin 601 (see FIG. 6) for ensuring the proper positioning of the power sockets 202 and 204 and the proper positioning of female signal contact 206 when cable assemblies 112 and 114 are inserted into body 118. As shown in FIG. 6, when pin 601 is inserted into cavity 501, a portion of the pin 601 will extend into cavity 402 and engage with a circumferential groove 602 in a portion of a connector 603 of signal cable assembly 114. A portion of pin 601 may also extend into cavity 401 so that the pin will contact and press against the power cable assembly 112 to ensure its proper positioning. This is further illustrated in FIG. 11, which shows the positional relationship between locking pin and cables assembly 112 and 114 when inserted into body 118.

FIG. 8 is a perspective view of socket 104. This view shows not only undercut 134 for receiving hook 132, but also shows an undercut 834 for receiving hook 232.

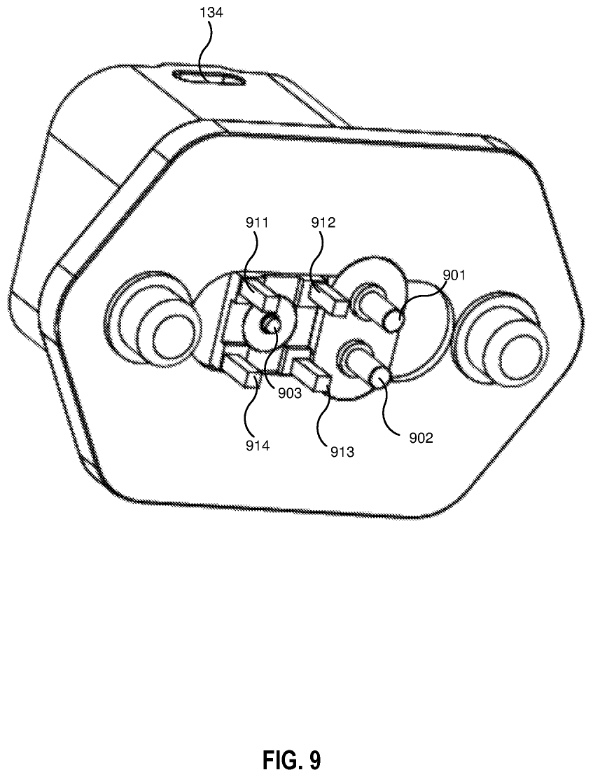

FIG. 9 illustrates the rear of socket 104. As shown in FIG. 9, there is a first solder tail 901 electrically connected to power pin 120 and a second solder tail 902 electrically connected to power pin 121. As further shown in FIG. 9, connector 122 is swaged in place. Connector 122 has a solder tail 903 (e.g., a plated through hole solder tail as shown) electrically connected to signal pin 801 of connector 122 and solder tails 911, 912, 913, and 914 electrically connected to shielding that surrounds pin 801. The above mentioned solder tails are configured to be soldered to a circuit board.

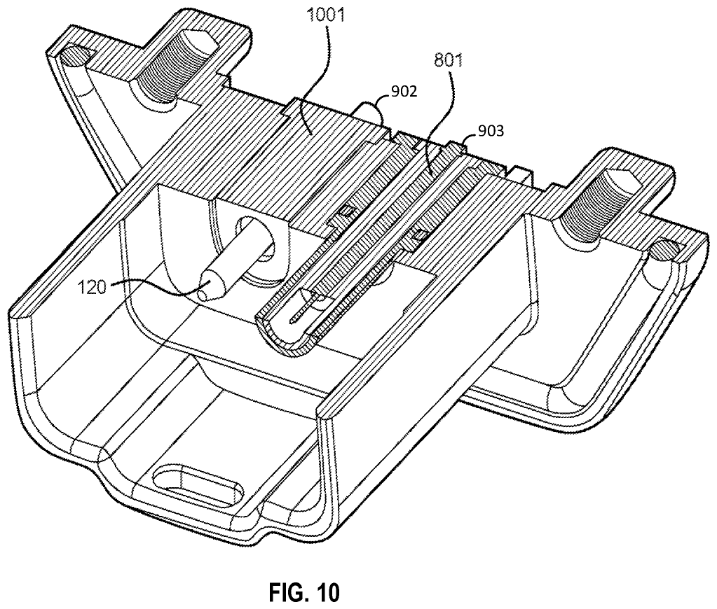

FIG. 10 is a cross-sectional view of socket 104, which further illustrates signal pin 801 and power pin 120. As shown in FIG. 10, the middle portion of power pin 120 is retained within a housing barb 1001, which is formed from a dielectric material.

FIG. 11 shows that in some embodiments the power cable assembly 112 and signal cable assembly 114 are independently environmentally sealed. For example, as shown in FIG. 11 a resilient o-ring sits in circumferential groove of the connector portion of signal cable assembly 114, which connector portion is housed within cavity 402 of body 118, and another resilient o-ring sits in circumferential groove of a portion of signal cable assembly 114 housed within cavity 401 of body 118.

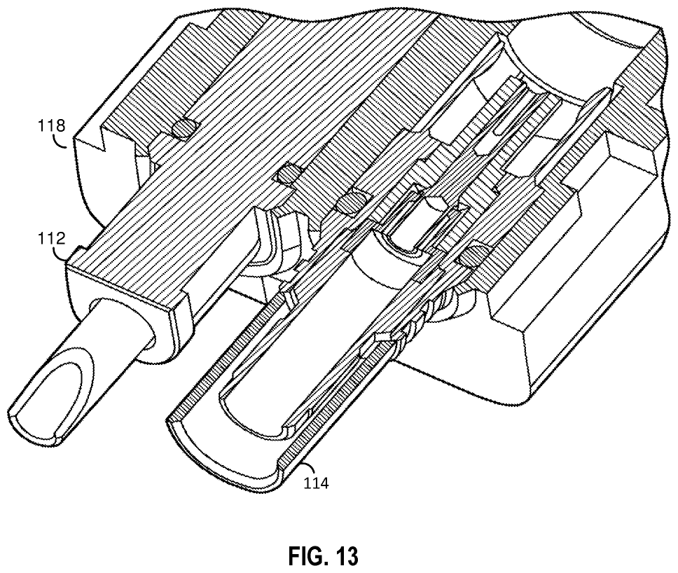

FIG. 12 and FIG. 13 show another embodiment of body 118. This embodiment does not include the transverse cavity 501 and the lock pin 601. After the end portion of cable 112 is inserted into cavity 401, the cable is locked in place by swaging in several places a raised rim 1201 that surrounds the entrance to cavity 401; likewise, after the end portion of cable 114 is inserted into cavity 402 the cable 114 is locked in place by swaging in several places a raised rim 1202 that surrounds the entrance to cavity 402. In one embodiments, the rims are about 0.015 inches wide. This connector retention method has an advantage of being easier to manufacture than the lock pin embodiment.

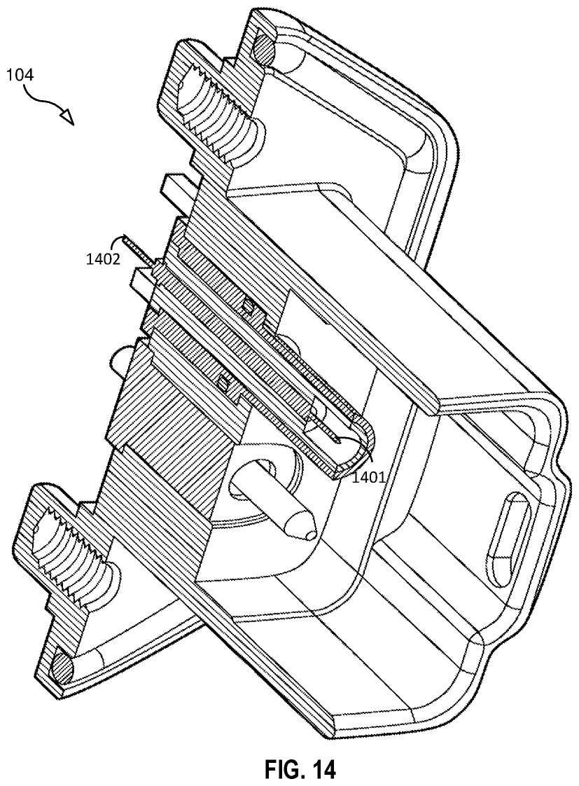

FIG. 14 illustrates another embodiment of socket 104 in which signal pin 801 is replaced with a signal pin 1401 having a solder tail 1402 connector achieving excellent RF characteristics.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A hybrid plug, comprising:
a metallic plug body;
a latching shroud, connected to the plug body, for engaging with a corresponding hybrid socket, wherein
the plug body has a first cavity for receiving a power cable assembly for delivering power, and
the plug body further has a second cavity for receiving a signal cable assembly for carrying a data signal.

2. The hybrid plug of claim 1, wherein
the first cavity extends from the rear of the plug body to the front of the body, and
the second cavity extends from the rear of the plug body to the front of the plug body.

3. The hybrid plug of claim 1, wherein
the plug body has a first side and a second side opposite the first side,
a first channel is formed in the first side,
a second channel is formed in second first side,
the latching shroud comprises a first u-shaped cantilever arm and second u-shaped cantilever arm,
a portion of the first u-shaped cantilever arm is received in the first channel,
a portion of the second u-shaped cantilever arm is received in the second channel.

4. The hybrid plug of claim 3, wherein
a first hook is formed on the first u-shaped cantilever arm and the first hook is configured to engage with a first undercut of the socket when the plug is engaged with the socket, and
a second hook is formed on the second u-shaped cantilever arm and the second hook is configured to engage with a second undercut of the socket the plug is engaged with the socket.

5. The hybrid plug of claim 4, wherein
the first u-shaped cantilever arm comprises a first connector release latch for disengaging the first hook from the first undercut, and
the second u-shaped cantilever arm comprises a first connector release latch for disengaging the second hook from the second undercut.

6. The hybrid plug of claim 5, wherein
the latching shroud includes a first moveable protective cover for covering the first connector release latch and a second moveable protective cover for covering the second connector release latch.

7. The hybrid plug of claim 6, wherein
the first protective cover is configured to slide between a first position in which the first connector release latch is exposed and a second position in which the first protective cover covers the first connector release latch so that it is not exposed, and
the second protective cover is configured to slide between a first position in which the second connector release latch is exposed and a second position in which the protective cover covers the first connector release latch so that it is not exposed.

8. The hybrid plug of claim 7, wherein
the first protective cover comprises side surfaces that define an opening leading to a cavity within the first protective cover, and
when the first protective cover is moved into the second position, the first connector release latch is disposed in the cavity, thereby preventing unintentional disengagement of the plug from the socket.

9. The hybrid plug of claim 8, wherein
the first protective cover comprises a first cantilever arm connected to a first side of the first protective cover and a second cantilever arms connected to a second side of the first protective cover,
the first cantilever arm has a hook at its distal end for engaging with a first recess in latching shroud when the first protective cover is moved to the second position, and
the second cantilever arm has a hook at its distal end for engaging with a second recess in latching shroud when the first protective cover is moved to the second position.

10. The hybrid plug of claim 3, wherein
the plug body has a third side and a fourth side opposite the third side,
a third channel is formed in the third side,
a fourth channel is formed in fourth first side,
the latching shroud comprises a first cantilever locking arm and second cantilever locking arm,
the first cantilever locking arm is received in the third channel, and
the second cantilever locking arm is received in the fourth channel.

11. The hybrid plug of claim 10, wherein
the first locking arm has a hook at its distal end for engaging with a recess in the third channel, and
the second locking arm has a hook at its distal end for engaging with a recess in the fourth channel.

12. A hybrid socket, comprising:
a metallic socket body;
a first power pin for matting with a first power socket of a power cable assembly; and
a signal connector for mating with a signal contact of a signal cable assembly, wherein
both the first power pin and the signal connector are housed within the metallic socket body.

13. The hybrid socket of claim 12, further comprising:
a second power pin for matting with a second power socket of power cable assembly.

14. The hybrid socket of claim 12, wherein the signal connector is a coaxial connector.
